(19) United States
(12) Patent Application Publication
(10) Pub. No.: US 2019/0296604 A1
(43) Pub. Date: Sep. 26, 2019

(54) MOTOR VEHICLE STARTER WITH REINFORCED SEALING

(71) Applicant: Valeo Equipements Electriques Moteur, Creteil (FR)

(72) Inventors: Fabrice Marsac, ST Quentin Fallavier (FR); Thierry Paltrie, ST Quentin Fallavier (FR)

(73) Assignee: Valeo Equipements Electriques Moteur, Creteil (FR)

(21) Appl. No.: 16/303,157

(22) PCT Filed: May 11, 2017
(86) PCT No.: PCT/FR2017/051129

§ 371 Date: Nov. 20, 2018

(30) Foreign Application Priority Data
May 27, 2016 (FR) 1654772

(51) Int. Cl. H02K 5/173; H02K 5/22; H02K 5/167; H02K 5/10; H02K 1/18

(52) U.S. Cl. CPC H02K 5/1732; H02K 5/225; H02K 1/185; H02K 5/10; H02K 5/1672

(57) ABSTRACT

Starter (1), in particular for a motor vehicle, comprising:—a casing (3);—a rear bearing (5) secured to a rear end of the N casing (3);—a seal between the rear bearing (5) and the casing (3); the starter (1) further comprising:—a lateral opening along the outer periphery (32) of the casing (3);—a grommet (37), mounted in the lateral opening, for leading electric wires, which supply power to the starter (1), through the casing (3).

The present invention relates to the field of starters, and in particular to starters for motor vehicles,

Starters comprise an electric motor. The electric motor comprises a yoke in which coils or magnets which form poles are disposed. The rear part of the yoke is closed by a cover which covers the end of the yoke, and comprises the rear bearing supporting the drive shaft of the starter. The cover is secured on the yoke by means of fastenings such as, for example, longitudinal tie rods which are situated on the outside of the yoke, and retain the cover against the yoke, However, the number of tie rods is generally limited, for example to two, in order to limit the size as well as the costs, such that tightening of the tie rods tends to deform the cover. The latter is then intermittently no longer in contact with the yoke, such that the sealing between the yoke and the cover can no longer be ensured. Liquid comprising water, in particular saline water, can then penetrate into the yoke by capillarity between the yoke and the cover in the locations where there is no longer contact between the cover and the yoke.

However, penetration of this type of this liquid into the yoke can give rise to oxidation of the brushes and the brush-holder of the electric motor. It is therefore necessary to avoid penetration of this type of liquid from the outside in order to avoid the presence of corrosion at the brushes, and to ensure satisfactory operation of the starter in the long term, in particular for more than 10 years.

A first means according to the prior art consists of forming a flow between the inside and the outside of the yoke at the cover or the rear bearing, such as to discharge liquids which are in transit and stagnating in this portion. This solution makes it possible in particular to avoid the stagnation of liquids, and limits the erosion of the yoke and the rear cover.

Alternatively, a second means according to the prior art consists of forming a sealed junction between the yoke and the rear bearing, for example by means of an O-ring seal, in order to prevent the liquid from penetrating at this junction.

However, a seal of this type does not necessarily ensure good sealing since, because of the deformation of the cover by the tie rods, the compression of the seal is not homogenous, which leads to openings being left even when the seal is present.

In addition, in this last alternative, a grommet which directs the supply wires is arranged in a notch in the rear bearing. The latter is generally made of a rubbery material in order to form a seal. A disadvantage of a notch of this type is that it contributes towards the deformation of the rear bearing when the latter is kept under tension on the rear end of the yoke. In fact, the notch reduces the rigidity of the part, since the quadratic modulus is considerably reduced locally. This has the consequence that the circumferential sealing between the rear hearing and the yoke is not regular.

Thus, the objective of the present invention is to protect the starter of a motor better, against corrosion of the brushes and/or the brush-holder.

According to one aspect, the invention relates to a starter, in particular for a motor vehicle, comprising:

a yoke which extends along an axis, known as the axis of revolution;

a rear bearing comprising a lateral part which overlaps an axial end of the yoke; and

a seal which is disposed between the rear bearing and the yoke at the said overlapping.

The rear bearing also comprises a continuous section around its entire periphery on a plane orthogonal to the axis of revolution, the said section intersecting the rear bearing at the overlapping.

According to one embodiment, there is a continuous section around the entire periphery of the rear bearing on the entire plane orthogonal to the axis which intersects the rear bearing at the overlapping.

According to one embodiment, the rear end of the yoke and the end of the rear bearing comprise an end circumferential portion which ensures continuous contact between a surface of the yoke and the surface of the rear bearing. According to one embodiment, this continuous contact is contact which is locally flat, but extends around the entire circumference of the starter in an annular contact.

According to another aspect, the invention relates to a starter, in particular for a motor vehicle, comprising:

a yoke;

a rear bearing secured on a rear end of the yoke;

a seal disposed between the rear bearing and the yoke.

The starter additionally comprises:

a lateral aperture provided in the outer periphery of the yoke;

a grommet fitted in the lateral aperture for the passage of electrical supply wires of the starter.

An advantage is to propose a solution which is robust, sealed, and limits the deformations of the rear bearing. The solution according to the invention permits better distribution of the stresses on the periphery of the edge of the rear hearing.

According to one embodiment, the lateral aperture is a notch which opens onto part of the rear end of the yoke. An advantage is to form a single joining space between the grommet and the seal.

According to one embodiment, the lateral aperture is a hole which passes through the lateral face of the yoke. An advantage is to keep an edge of the rear end of the yoke robust and insensitive to the deformations associated with the compression stresses.

According to another aspect, the invention relates to a starter, in particular for a motor vehicle, comprising:

a yoke;

a rear bearing secured on a rear end of the yoke;

a seal disposed between the rear bearing and the yoke;

a lateral aperture forming a hole passing through the outer periphery of the rear bearing;

a grommet fitted in the said lateral aperture for the passage of electrical supply wires 38 of the starter.

According to one embodiment, the lateral aperture comprises a continuous lateral edge around its entire inner periphery.

According to one embodiment, on a plane perpendicular to the axis of the starter, and intersecting the rear bearing between the lateral aperture and the yoke, the starter comprises a section of the rear bearing which extends around 360°, whilst surrounding a hole.

According to one embodiment, the starter comprises a hoop which covers part of the outer surface of the body of the rear bearing, the said hoop comprising a hoop aperture forming a through-hole which extends the lateral aperture, the said hoop aperture having larger dimensions than the lateral aperture, such as to define a border around the lateral aperture for retention of the grommet.

The following characteristics are applicable alone or in combination to any one of the aspects of the invention described above.

According to one embodiment, the grommet covers all of the :surface of the lateral aperture, such as to form a seal, which in particular is watertight, between the outside and the inside of the periphery of the lateral aperture.

According to one embodiment, the rear bearing forms a cover comprising a closure section, and a lateral part, the lateral part cooperating with an inner or outer surface of the yoke, the said rear bearing comprising at least two openings in which fastening rods keep the rear bearing integral with the yoke, the rods extending along the yoke and being secured on a support of the starter.

An advantage is to provide a solution which keeps the parts integral with one another, whilst limiting the weight of the starter 1.

According to one embodiment, the lateral part of the rear bearing comprises a skirt which covers the rear end of the yoke. An advantage is to define a solution which provides better rigidity when the parts are connected, and better sealing.

According to one embodiment, the covering skirt comprises two radial additional thicknesses in which the openings which form longitudinal holes for passage of the securing rods are provided.

The lateral part of the rear bearing comprises an outer surface and an inner surface, a portion of which is designed to be in contact with an outer portion of the yoke.

According to one embodiment, the lateral part of the rear bearing comprises on its outer surface a reinforcement rib which extends on a portion of the end of its lateral part. An advantage is to reinforce the mechanical strength of the rear bearing which is subjected to compression and flexure stress by the tie rods. The reinforcement rib can preferably define a continuous portion around the circumference of the rear bearing, such as to limit its deformations.

According to one embodiment, the lateral part of the rear bearing comprises a portion which overlaps the yoke, this portion comprising, on a plane orthogonal to the axis on which the yoke extends, a continuous section, for example a crown. An advantage is to reinforce the junction between the yoke and the rear support.

According to one embodiment, the rear end of the yoke arid; or the lateral part of the rear bearing comprise(s) a groove which is designed to receive the seal. An advantage is better retention of the seal, and a reduced space in which the liquid can circulate in contact with the seal.

According to one embodiment, the rear bearing comprises a circumferential chamfer forming a surface for retention of the seal. This chamfer is machined on the inner surface of the lateral part of the rear bearing. The machining of the rear bearing which defines a chamfer makes it possible to improve the retention of the seal, and thus provides better sealing of the starter.

According to one embodiment, the grommet comprises a groove which is designed to receive a portion of the sea extending the groove in the yoke on the portion of the notch. Thus, this solution makes it possible to reinforce the sealing of the starter, whilst defining facilitated integration of the seal.

According to one embodiment:

the rear bearing is made of aluminum;

the yoke is made of steel;

the seal is an O-ring seal or a lip seal; and/or

the grommet is made of a thick rubbery material.

According to one embodiment, on a plane perpendicular to the axis of the starter and intersecting the seal, the starter comprises a section of the rear bearing which extends around 360° whilst surrounding a hole.

This makes it possible to improve the sealing of the starter between the yoke and the rear bearing.

According to one embodiment, the seal is annular.

According to one embodiment, the seal is distinct from the grommet.

Other characteristics and advantages of the invention will become apparent from reading the following detailed description, with reference to the appended figures, which illustrate:

FIG. 1 is a three-dimensional representation of a first embodiment of a starter comprising a yoke, a rear bearing and a grommet;

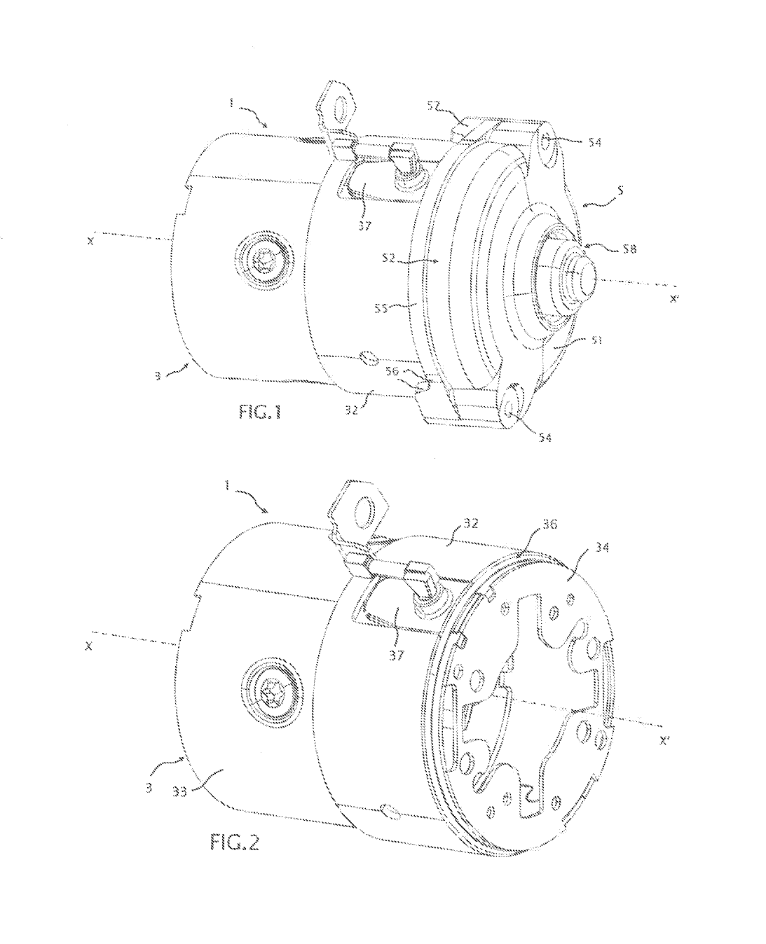

FIG. 2 is a three-dimensional representation of a starter, on which the removal of the rear bearing shows a junction plate;

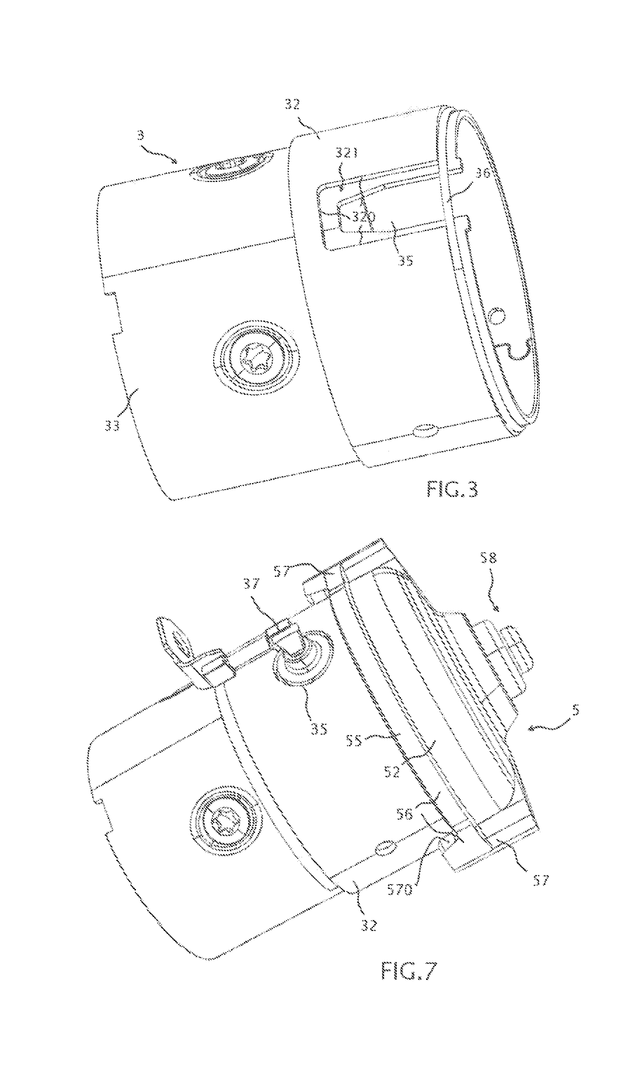

FIG. 3 is a three-dimensional representation of a starter, on which the removal of the grommet shows an aperture forming an opening notch;

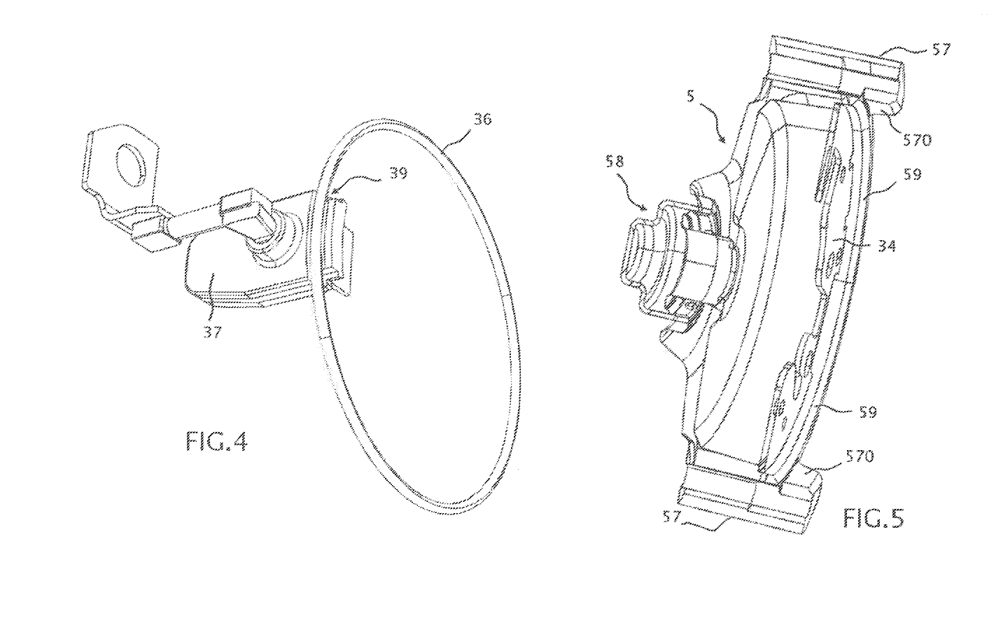

FIG. 4 is a three-dimensional representation of a junction between a grommet of a starter according to the invention and a seal;

FIG. 5 is a three-dimensional representation of a junction between a grommet of a starter according to the invention and a seal;

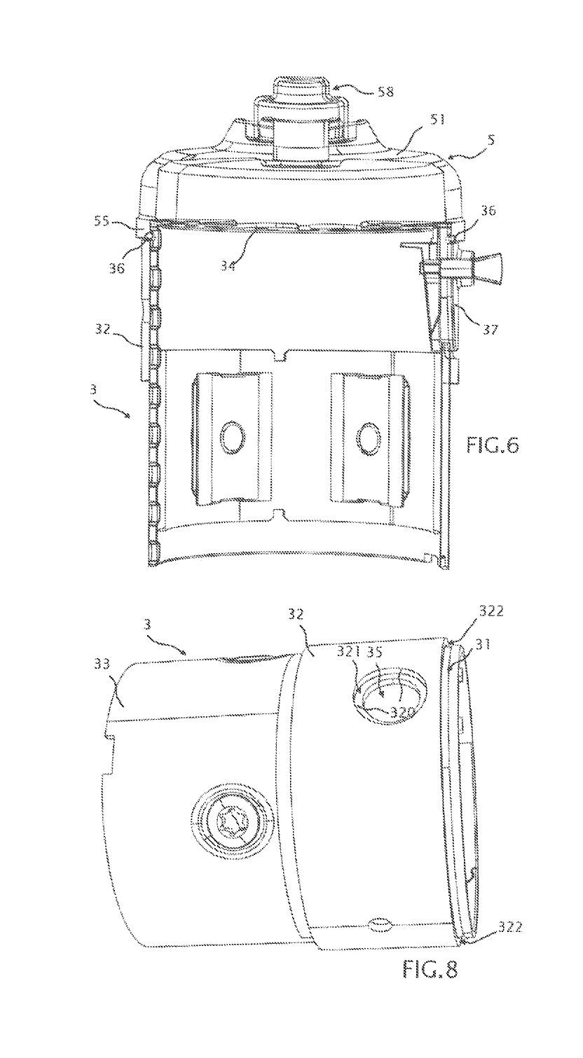

FIG. 6 is a cross-section of a starter in which there are represented a section of the yoke, of the rear bearing and of the grommet;

FIG. 7 is a representation of a second embodiment in which a grommet is arranged in an aperture passing through the body of the yoke and comprising a closed periphery;

FIG. 8 is a representation of the second embodiment in which the grommet is removed in order to show the aperture; and

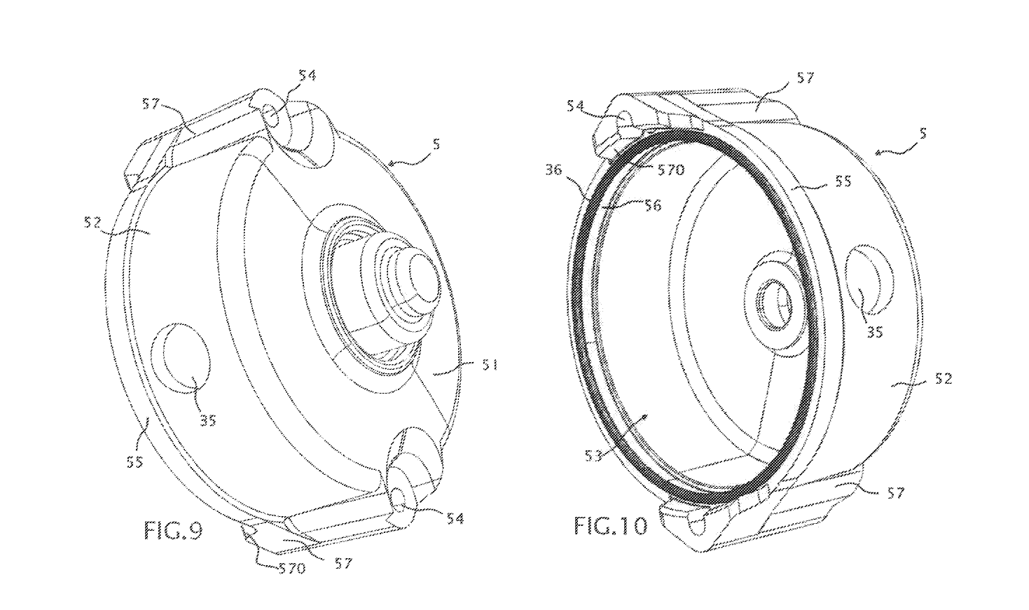

FIGS. 9 and 10 are two three-dimensional views of a third embodiment, in which the rear bearing comprises an aperture arranged beyond the reinforcement rib which borders the circumferential end of the part.

The following embodiments are examples. Although the description refers to one or more embodiments, this does not necessarily mean that each reference relates to the same embodiment, or that the characteristics apply only to a single embodiment. Simple characteristics of different embodiments can also be combined in order to provide other embodiments.

The yoke 3 has a form generally substantially of revolution according to an axis of revolution X-X′. This is the axis according to which the largest dimension of the yoke 3 extends. In the present description, reference will be made without distinction to the axis of revolution X-X′ of the yoke or the axis along which the yoke 3 extends. According to one embodiment, the yoke 3 has a substantially cylindrical form.

The rear bearing 5 forms a cover of the yoke 3. It is designed such as to cooperate with an end of the yoke 3: this is the rear end of the yoke 3. Consequently, the form of the rear bearing 5 is designed to cooperate with the rear end of the yoke 3. According to one embodiment, the rear bearing 5 thus has a substantially cylindrical form.

FIG. 1 represents an embodiment of the invention in which the yoke 3 and the rear bearing 5 are assembled.

The rear bearing 5 comprises a closure Lace 51 which forms a cover base and a main aperture 53 in which the rear end of the yoke 3 is inserted. The closure face 51 of the rear bearing 5 comprises in its centre an aperture in a central part 58 for the passage of the drive shaft which passes through the yoke. The central part has the form of a stopper comprising a central opening.

The closure face 51 and the main aperture 53 of the rear bearing are represented better by examining FIG. 10, the perspective of which shows the inside of the rear bearing 5.

The rear bearing 5 comprises a lateral face 52 which is annular, the diameter of which is slightly larger or slightly smaller than the diameter of the yoke 5, in order to insert one part in the other. Hereinafter in the description, the rear bearing 5 is described with a diameter larger than the diameter of the rear end of the yoke 3. However, the invention also applies to the variant in which the main end aperture 53 of the rear bearing 5 is inserted in the rear end of the yoke 3, with the rear end of the yoke 3 then covering a portion of the rear bearing 5.

According to one embodiment, a plate 34 is arranged between the rear bearing 5 and the yoke 3. FIG. 2 represents an embodiment of a plate 34 of this type. According to one embodiment, the plate 34 comprises a central aperture for the passage of the drive shaft, which rotates around the axis of revolution X-X′. According to one embodiment, the plate 34 provides a surface on its circumference defining an edge which, according to one embodiment, can contribute to retaining the seal 36. In addition, the edge of the plate makes it possible to provide a support surface in order to position the plate 34 on the yoke 3 or on the rear bearing 5. In this last case, the rear bearing 5 or the yoke 3 can comprise a circumferential stop which is designed to receive the border of the plate 34.

FIG. 6 represents a view in cross-section of the starter 1, and illustrates an embodiment in which the plate 34 provides a support surface for the yoke 3 when the parts are assembled. The plate 34 is itself retained thanks to the presence of a circumferential stop.

Advantageously, according to one embodiment, the plate 34 defines an edge of the groove 31 in which the seal 36 is inserted.

According to one embodiment, the yoke is made of steel. The steel makes it possible to protect the yoke 3 against surrounding parasitic electromagnetic effects of the mechanical parts. In general, the yoke 3 has rigidity greater than that of the rear bearing 5. For example, the rear bearing 5 can be made of aluminium.

According to one embodiment, the yoke 3 can comprise an additional hoop 32 which covers partly the outer surface of the body 33 of the yoke 3. The additional hoop 32 can be made of the same material as the body 33 of the yoke, or from a different material. FIG. 6 represents a view in cross-section of the additional hoop 32 extending on a portion of the yoke 3.

The rear bearing 5 is secured on the yoke by means of fastening rods, also known as tie rods. The fastening rods are not represented in the figures. The fastening rods make it possible to secure the rear bearing 5 on a support of the yoke which is arranged at another end of the latter. Under the force of the fastening rods clamping the parts, the rear bearing 5 and thus the yoke 3 are subjected to compression forces.

According to one embodiment, an assembly of tie rods keeps the yoke 3 and the rear bearing 5 secured to one another. According to one embodiment, the two tie rods extend along the axis of revolution X-X′ of the yoke 3. In this last case, they can advantageously be arranged diametrically opposite the form of revolution of the yoke 3.

According to one embodiment, the rear bearing 5 comprises longitudinal openings 54, each being provided in an radial additional thickness 57. The longitudinal openings 54 provide a function of retention and guiding of the tie rods extending along the yoke 3. They are preferably oriented parallel to the axis of revolution X-X′ of the yoke.

Three main embodiments of the invention are described hereinafter.

It is specified that, when a hole is said to be a “through-hole”, reference is being made indiscriminately to a hole which passes through the surface of a part, or a hole which passes through the body of the part, provided that the hole forms a passage between the outside and the inside of the part.

According to a first main embodiment, the aperture is a notch 35 formed in the lateral body 33 of the yoke 3. The notch 35 opens onto the rear end of the yoke 3. In this case, the lateral aperture 35 is not defined by a closed perimeter. FIGS. 1 to 6 illustrate this first main embodiment.

According to a second main embodiment, the aperture is hole which passes through the lateral body 33 of the yoke 3. In this case, the lateral aperture 35 can be defined by a closed perimeter. FIGS. 7 and 8 illustrate this second main embodiment.

According to a third main embodiment, the aperture is a hole which passes through the surface of the rear bearing 5. In this embodiment, the yoke 3 does not comprise an aperture in which the grommet 37 can be arranged. The latter is arranged in the aperture in the rear bearing 5. In this case, the lateral aperture 35 can be defined by a closed perimeter. FIGS. 9 and 10 illustrate this third main embodiment.

According to each of the embodiments of the invention, a lateral aperture 35 is designed to receive a grommet 37.

FIG. 1 represents an embodiment in which the grommet 37 is arranged in the lateral aperture 35 in the yoke 3. FIG. 3 represents the same embodiment with the lateral aperture 35 without the grommet 37.

The grommet 37 is designed to be retained. in the lateral aperture 35. For this purpose, its form, its material and its arrangement in the lateral aperture 35 are defined such as to optimise its retention in the lateral aperture 35, and to ensure sealing inside the yoke 3 relative to the external environment of the yoke 3.

In order to ensure the sealing of the starter 1, the grommet 37 which is necessary in order to direct the power supply to the starter 1 is made of a rubbery material. Advantageously, the rubbery material covers all of the lateral aperture 35. The dimensions of the lateral aperture 35 are thus designed for the passage of the wires and for a minimum quantity of material which is designed to seal the area of the aperture.

The rubbery material also makes it possible to prevent short circuits. In addition, the quantity of material of the grommet 37 has dimensions such as to withstand increases in temperature during the operation of the starter 1, and to withstand deformations induced by the said increases in temperature.

When an additional hoop 32 of the yoke 3 covers a circumferential part of the body of the yoke 3, the lateral aperture 35 which is designed to receive the grommet 37 is extended to the surface of the hoop 32, if the latter is to overlap the lateral aperture 35.

FIGS. 3 and 8 make it possible to represent an embodiment of this type, in which the hoop 32 comprises an aperture 321 which is larger than the lateral aperture 35. An advantage of the hoop 32 is that it makes it possible to wedge the seal 36 axially, and thus to maintain sealed contact between the yoke 3 and the rear bearing 5.

The lateral aperture 35 is produced such as to avoid making the border of the rear bearing 5 fragile. In fact, the rear bearing 5 is subjected to strong compression and flexure stresses, and can be made fragile by any machining giving rise to asymmetry on its border, which could for example be caused by the presence of a notch provided at the end of the rear bearing 5. This solution would not make it possible to seal the starter 1 efficiently after a given duration of operation.

Since the yoke 3 is made of steel, the lateral aperture 35 provided in its surface contributes far less to the deformation of the starter 1 than the solution in which the notch would be provided in the border of the rear bearing 5, which is made of aluminium. In fact, most of the forces are withstood by the rear bearing 5, which is retained by the tie rods and not by the yoke 3. The yoke 3 which receives the rear bearing 5 is therefore not subject to flexure stress, but only to compression stress, indirectly by the tie rods.

Consequently, when the lateral aperture 35 is provided in the surface of the yoke 3, it does not make the starter 1 assembly fragile.

Furthermore, as illustrated by the prior art, persons skilled in the art are naturally led to form a notch in the rear hearing 5, since the part is easier to machine. They therefore have a prejudice against attempting to machine the yoke 3. However, a distinctive aspect of the invention is that the notch 35 provided in the yoke 3 makes it possible to obtain a starter 1 which is better sealed, and is therefore more resistant throughout the duration of its use.

Alternatively, according to the second embodiment, the lateral aperture 35 is a hole which passes through the body 33 of the yoke 3. In this case, the lateral aperture 35 has a closed perimeter. An advantage of this embodiment is of not making the border of the rear end of the yoke 3 fragile. In addition, this embodiment does not require particular adaptation of the grommet 37 to the seal 36, which is arranged at the junction of the rear end of the yoke 3 and of the rear bearing 5.

According to the third embodiment, the lateral aperture 35 is a hole which passes through the surface of the rear hearing 5. In this case, the lateral aperture 35 has a closed perimeter. An advantage of this embodiment is of not making the border of the rear end of the yoke 3 fragile. In addition, this embodiment does not require particular adaptation of the grommet 37 to the seal 36, which is arranged at the junction of the rear end of the yoke 3 and of the rear bearing 5.

In addition, the through hole 35 provided in the surface of the rear bearing is provided beyond a reinforcement rib 55 described hereinafter. This solution makes it possible to avoid making the border of the rear bearing 5 fragile, and contributes to reinforcing its rigidity. The through hole 35 provided beyond the reinforcement rib 55 limits its contribution to the deformations of the rear bearing 5 generated by the compression and flexure stresses caused by the tie rods.

According to one embodiment, the rear bearing 5 comprises a portion which overlaps the yoke 3 when the rear bearing 5 is assembled on the yoke 3. The portion which overlaps the yoke 3 forms a skirt 56 which covers the rear end of the yoke 3.

According to one embodiment, this covering skirt 56 extends around the entire circumference of the edge of the rear bearing 5, and also at the radial additional thicknesses 57,

According to one embodiment, each radial additional thickness 57 extends the covering skirt 56 in order to form an extension lip 570 which extends on a portion of the yoke 3. The extension lips 570 extend on the surface of the yoke in the direction of the axis of revolution X-X′. FIGS. 7, 9 and 10 illustrate the covering skirt 56, the radial additional thicknesses 57, and the extension lips 570.

According to one embodiment, the rear bearing 5 comprises two extension lips 570. According to another embodiment, the rear bearing 5 comprises a plurality of extension lips 570.

According to another embodiment, the portion which overlaps the rear end of the yoke 5 covers a continuous portion of the circumference of the yoke 3. In this embodiment, the entire section of the portion of the rear hearing 5 which overlaps the rear end of the yoke 3 defines a continuous section.

According to another embodiment, the rear end of the yoke 3 overlaps a portion of the lateral surface of the rear bearing 5. This embodiment is not represented, and is an alternative embodiment of the invention which is compatible with all the embodiments.

The starter 1 according to the invention comprises a seal 36 in order to seal the inside of the yoke 3 when it is secured on the rear bearing 5. A function of the seal 36 is to prevent the circulation of fluid from outside the starter 1 in the yoke.

According to one embodiment, a seal 36 is arranged at the circumferential junction of the yoke 3 and of the rear hearing 5. FIG. 3 represents an embodiment of an arrangement of a seal 36 retained in a groove 31 in the yoke 3, which itself is represented in FIG. 8. Alternatively, the groove 31 can be provided in the inner surface of the lateral part 52 of the rear bearing 5. This last embodiment is not represented.

The seal 36 is designed to be in contact with an inner portion of the lateral part 52 of the rear bearing 5, when the latter is secured on the yoke 3. According to one embodiment, the rear bearing 5 comprises a circumferential chamfer 59 forming a contact surface with the seal 36, in order to maintain sealed contact between the yoke 3 and the rear bearing 5.

FIG. 5 represents a chamfer 59 forming an annular contact surface in order to retain the seal 36. FIG. 5 also represents the plate 34 which is arranged in the rear bearing 5, and which, according to a particular embodiment, can form an additional contact surface in order to retain the seal 36,

When an additional hoop 32 is arranged on the surface of the body 33 of the yoke 3, an advantage is that it can be arranged such as to form an edge 322 at the rear end of the yoke 3 which makes it possible to define a surface for retention of the seal 36 when it is disposed in the groove 31. FIG. 6 also illustrates the contact between the additional hoop 32 and the seal 36.

According to one embodiment, the seal 36 is an O-ring seal. According to another embodiment, the seal 36 is a lip seal.

When the aperture 35 which is designed to receive the grommet 37 is a notch which opens at the rear end of the yoke 3, as represented in FIG. 3, the grommet 37 comprises a groove 39 which is designed to receive a portion of the seal 36. In this embodiment, the groove 39 in the grommet 37 completes and extends the groove 31 in the yoke 3. FIG. 4 represents the junction between the grommet 37 and the seal 36 extending the groove 31 in the form of a rubbery groove 39.

FIGS. 2 and 4 represent a grommet 37 comprising a portion which is designed to receive a part of the seal 36. The grommet 37 comprises a portion in contact with the seal 36, such as to contribute to the sealing of the starter 1.

According to one embodiment, the rear bearing 5 comprises a reinforcement rib 55 arranged on its periphery at the end of the edge of its circumferential aperture 53. The rib 55 is arranged on the outer surface of the rear bearing 5.

The reinforcement rib 55 extends on a plane orthogonal to the axis on which the yoke 3 extends. According to one embodiment, the cross-section of the reinforcement rib 55 forms a ring, and it is said to be annular. According to other embodiments, the cross-section of the reinforcement rib 55 has the same profile as a cross-section of the rear bearing 5, on a plane orthogonal to the axis of revolution.

According to one embodiment, the reinforcement rib 55 forms an additional thickness on a portion of the outer surface of the lateral part of the rear support 5. The reinforcement rib 55 can be created by addition of material.

Advantageously, the reinforcement rib 55 is present at the overlapping of the rear bearing 5 and the yoke 3.

FIGS. 1, 7, 9 and 10 represent a reinforcement rib 55 which appears to be combined with the part which forms the covering skirt 56. According to a first variant, the width of the reinforcement rib 55 can correspond to the width of the covering skirt 56, i.e. to the part which overlaps the yoke 3, in particular on the parts which do not correspond to the radial additional thicknesses 57.

According to another variant, the reinforcement rib 55 can extend at the surface of the rear bearing 5 on a width which exceeds the width of the covering skirt, thus providing better mechanical strength of the part.

According to another variant, the width of the reinforcement rib 55 can be narrower than the part which forms the covering skirt 56, such as to save material, and thus reduce the weight of the part. This solution provides increased compactness of the starter 1.

According to another embodiment., the reinforcement rib 55 is a hoop or a ring for retention of a portion of the surface of the lateral part of the rear bearing 5. According to one embodiment, the reinforcement rib can comprise an additional thickness of material and an additional hoop.

The reinforcement rib 55 provides better resistance of the rear bearing 5 to deformations, when the latter is subjected to mechanical stress. The stresses can for example be associated with the fastening rods exerting a constant force on the mechanical parts which are thus rendered integral.

According to one embodiment, a second reinforcement rib, not represented, can be provided around the through hole 35 in the rear hearing 5, which. hole forms the lateral aperture. This solution is intended to reinforce the recessed part of the lateral bearing 5 forming the lateral aperture 35. This second reinforcement rib can be provided in all the embodiments, including those in which the lateral aperture 35 is provided in the body 33 of the yoke 3.

1. A starter for a motor vehicle, comprising:
a yoke;
a rear bearing secured on a rear end of the yoke;
a seal disposed between the rear bearing and the yoke;
a lateral aperture provided in the outer periphery of the yoke; and
a grommet fitted in the lateral aperture for the passage of electrical supply wires of the starter.

2. The starter according to claim 1, wherein the lateral aperture is a notch which opens onto part of the rear end of the yoke.

3. The starter according to claim 1, wherein the lateral aperture is a hole which passes through the lateral face of the yoke.

4. The starter according to claim 1, wherein the grommet covers all of the surface of the lateral aperture, such as to form a seal, which is watertight, between the outside and the inside of the periphery of the lateral aperture.

5. The starter according to claim 1, wherein the rear bearing forms a cover comprising a closure section, and a lateral part, the lateral part cooperating with an inner or outer surface of the yoke, the said rear bearing comprising at least two openings in which fastening rods keep the rear bearing integral with the yoke, the rods extending along the yoke and being secured on a support of the starter.

6. The starter according to claim 5, wherein the lateral part comprises a skirt which covers the rear end of the yoke.

7. The starter according to claim 6, wherein the covering skirt comprises two radial additional thicknesses in which the openings which form longitudinal holes for passage of the securing rods are provided.

8. The starter according to claim 5, wherein the lateral part of the rear bearing comprises on its surface a reinforcement rib which extends on a portion of the end of its lateral part.

9. The starter according to claim 5, wherein the lateral part of the rear bearing comprises a portion which overlaps the yoke, the portion comprising, on a plane orthogonal to the axis on which the yoke extends, a continuous section, that is a crown.

10. The starter according to claim 1, wherein the rear end of the yoke and/or the lateral part of the rear bearing comprise(s) groove which is designed to receive the seal.

11. The starter according to claim 1, wherein the rear bearing comprises a circumferential chamfer forming a surface for retention of the seal.

12. The starter according to claim 2, wherein the grommet comprises a groove which is designed to receive a portion of the seal extending the groove in the yoke on the portion of the notch.
